(19) United States
(12) Patent Application Publication
(10) Pub. No.: US 2009/0327425 A1
(43) Pub. Date: Dec. 31, 2009

(54) SWITCHING BETWEEN AND DUAL EXISTENCE IN LIVE AND RECORDED VERSIONS OF A MEETING

(75) Inventor: Ananta S. Gudipaty, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/145,982

(22) Filed: Jun. 25, 2008

(51) Int. Cl. G06F 15/16

(52) U.S. Cl. 709/205

(57) ABSTRACT

An asynchronous meeting system is presented that allows a meeting participant to seamlessly switch between live (synchronous) and recorded (asynchronous) meeting information. The asynchronous meeting system provides information to other meeting participants about the status of a meeting participant, including whether the meeting participant is viewing live or recorded meeting information. The asynchronous meeting system allows other meeting participants to notify the meeting participant when attention at the live meeting is desired. Thus, the asynchronous meeting system allows the meeting participant to more productively use his/her time at the meeting, but maintains the ability to have two-way, real-time communication that meeting participants expect.

### BACKGROUND

History has shown that most communication technologies, as they mature, evolve from being entirely synchronous to enabling asynchronous capabilities, for greater flexibility and increased productivity. Radio, for example, evolved from providing synchronous experiences to asynchronous options with recorded media such as cassettes and CDs. Similarly, telephones evolved by providing answering machines and voice mail, face-to-face interpersonal communication evolved to memos and e-mail, and television to VCRs, DVDs, and more recently Personal Video Recorders (PVRs) such as TiVo and Windows Media Center.

In all of the above mentioned areas, computing technologies have significantly enhanced this evolution by providing richer functionality, seamless transitions, and near dual existence in both synchronous and asynchronous modes. For example, the PVRs enable instant switching from synchronous (live television) to asynchronous (recorded television) and back, with capabilities such as rewinding live television and jumping ahead to live television from a recording. Similarly, instant messaging (IM) almost blurs the lines between synchronous and asynchronous experiences with its dual existence in the two modes.

Meetings, despite being a universally complained about activity, have seen relatively little benefit from all this evolution. While Data or Web Conferencing is promising to bridge the distance gap and eliminate at least some of the travel, meetings continue to be synchronous events. Recording is helping somewhat but the lack of proper content management tools along with discovery challenges have stunted its impact as well. While those limitations are being addressed in their own right, there is no real effort in the industry to bring the seamless asynchronous aspects to meetings. Meetings are different than the other communications technologies discussed above, because they involve two-way, real-time communication. Participants expect to interact with other participants without waiting. Thus, existing technologies (e.g., video and web conferencing) are typically focused on conveying live meeting information to participants with as little latency as possible so that participants do not perceive delays.

### SUMMARY

An asynchronous meeting system is presented that allows a meeting participant to seamlessly co-exist and switch between live (synchronous) and recorded (asynchronous) meeting information. The asynchronous meeting system provides information to other meeting participants about the status of a meeting participant, including whether the meeting participant is viewing live or recorded meeting information. The asynchronous meeting system allows other meeting participants to notify the meeting participant when attention at the live meeting is desired. Thus, the asynchronous meeting system allows the meeting participant to more productively use his/her time at the meeting, but maintains the ability to have two-way, real-time communication that meeting participants expect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of an asynchronous meeting system, in one embodiment.

FIG. 2 is a block diagram that illustrates the flow of meeting data in the asynchronous meeting system, in one embodiment.

FIG. 3 is a flow diagram that illustrates processing of a seek component to seamlessly transition from live to previously recorded meeting data, in one embodiment.

FIG. 4 is a flow diagram that illustrates processing of the seek component to seamlessly transition from previously recorded meeting data to live meeting data, in one embodiment.

FIG. 5 is a display diagram that illustrates a user interface of the asynchronous meeting system for displaying live and recorded meeting information at the same time, in one embodiment.

### DETAILED DESCRIPTION

An asynchronous meeting system is presented that allows a meeting participant to seamlessly switch between live (synchronous) and recorded (asynchronous) meeting information. The asynchronous meeting system provides three capabilities that enable numerous new meeting experiences: 1) capturing (in the background) the proceedings of a meeting in real-time, 2) conditionally rendering the live meeting or any segment of the captured data with near instant response and without impacting further capture, and 3) seeking to any point in the captured buffer or to the synchronous, current state of the meeting. Each of these capabilities is discussed in further detail herein. The asynchronous meeting system provides information to other meeting participants about the status of a meeting participant, including whether the meeting participant is viewing live or recorded meeting information. The asynchronous meeting system allows other meeting participants to notify the meeting participant when attention at the live meeting is desired. This allows the meeting participant to co-exist in both the live and recorded meeting. Thus, the asynchronous meeting system allows the meeting participant to more productively use his/her time at the meeting, but maintains the ability to have two-way, real-time communication that meeting participants expect.

The asynchronous meeting system enables many new meeting experiences that are not possible with current meeting technology. For example, a meeting participant can rewind live meetings. Suppose a participant Joe missed what a participant Sammy said in the meeting because he was distracted by his e-mail. It sounded like a relevant comment so Joe rewinds the meeting by a few seconds to hear the comment again. As another example, a meeting participant can pause a live meeting. Suppose John gets a call from his wife that he needs to answer. John can pause the meeting to attend to the call and once done, resume the meeting exactly where he left off. A participant can also join a meeting late and catch up. Suppose Hilary is ten minutes late to the meeting but she is able to start at the beginning and watch the entire presentation from beginning to end. She has essentially “time-shifted” the presentation by 10 minutes.

As another example, the asynchronous meeting system provides fast playback to catch-up. After pausing for five minutes, John resumes the meeting but plays it back in 2× speed to catch up to the live meeting (synchronous mode) in the next 5 minutes. The asynchronous meeting system also enables selective viewing. Sara joined the session 20 minutes late but is able to fast forward through a discussion that was not as relevant to her, catching up to sync mode and still being aware of the discussion. Participants can use the asynchronous meeting system to review previous comments. Paul wants to capture a work item that Sammy assigned to him 20 minutes earlier in the meeting. Paul can quickly jump back to the correct point in time and note the assignment. These and other scenarios are provided by the asynchronous meeting system.

Thus, the asynchronous meeting system not only improves productivity in the ways described above, but also in numerous other ways that are difficult or socially awkward currently. For example, the system allows participants to freely multi-task or dynamically tune the level of participation between the meeting and other activities, such as e-mail or instant messaging, without fear of missing something relevant. The system also avoids the awkward moment when a participant knows he or she has missed a relevant point, needs to admit being distracted, and asks for reiteration.

In the scenarios described above, the participants “time-shifting” the meeting are only passive participants—just listening to the discussion rather than contributing to it. However, the asynchronous meeting system also provides tools to ensure that asynchronous experiences of one meeting participant do not hinder the interactivity of the meeting. For example, the asynchronous meeting system provides a notification to other participants that a person has entered asynchronous mode (e.g., by displaying a different icon next to the person's name in a displayed participant list). The system also provides tools for other participants to “request” the asynchronous participant to enter synchronous mode when active participation is desired. The system provides presenters or organizers a mechanism to force everyone back to synchronous mode to convey a particular message. Finally, there are occasions when one or more participants feel the meeting was very productive and wish they had recorded it for future reference or for the benefit of others. The asynchronous meeting system allows participants to store the contents of the buffer of meeting data for later viewing, essentially making reactive-recordings possible.

The benefits of providing seamlessly integrated PVR or time-shifting functionality in online meetings are tremendous. In some embodiments, such a feature can be built at a relatively low cost by combining a recording pipeline with existing web conferencing infrastructure.

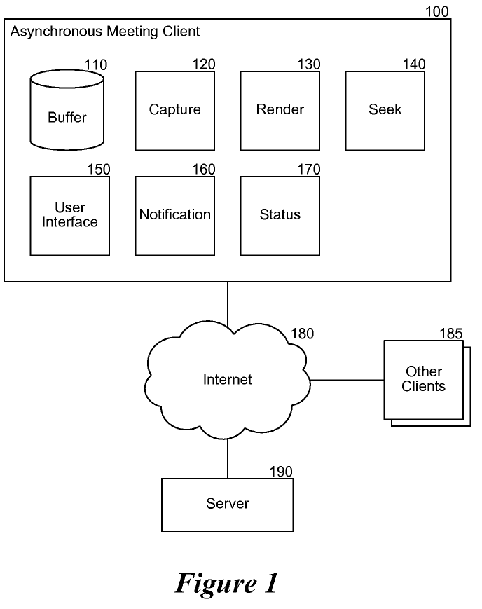

FIG. 1 is a block diagram that illustrates components of the asynchronous meeting system, in one embodiment. The asynchronous meeting system typically operates in an environment with an asynchronous meeting client 100 connected via a network 180 (e.g., the Internet) to a meeting server 190 and one or more other meeting clients 185. The meeting server 190 may relay meeting information and/or status information about meeting participants to other meeting participants. The asynchronous meeting client 100 includes a buffer 110, a capture component 120, a render component 130, a seek component 140, a user interface component 150, a notification component 160, and a status component 170. Each of these components is discussed in further detail below. The system may include other components typical of a web-conferencing system (e.g., audio, video, chat, data sharing, relay, and so forth) that are not discussed here for the sake of simplicity.

The buffer 110 stores meeting data or information as the meeting progresses. For example, the client 100 may route an incoming data stream of meeting data to the buffer. The buffer may contain audio data, video data, documents presented at the meeting, links to websites presented, and so forth. The capture component 120 manages the buffer 110 and retrieves the information presented at the meeting for storage in the buffer 110. For example, in one embodiment, if a page of a document is displayed at the meeting, the capture component 120 obtains the original source document file so that a meeting participant can later view any part of the document from the buffer 110.

In some embodiments, the asynchronous meeting system captures source meeting information and creates a storyboard. Traditional meeting recording techniques capture a frame buffer to create a minute-by-minute audiovisual recording of what took place at the meeting. The asynchronous meeting system captures the source of the information presented in addition to audio and video. For example, if a word processing document was presented, then the asynchronous meeting system captures the document itself. Thus, even though only a page or two of the document may have been presented at the meeting, the asynchronous meeting system has access to the whole document and can provide the document to a later viewer. The asynchronous meeting system creates a storyboard that relate events that occurred during the meeting to a timeline. The events may include audio or visual events as well as when a document was presented and information about the parts of the document that were presented at the meeting. In this way, the asynchronous meeting system captures rich information about the meeting.

The render component 130 renders meeting information for viewing by a meeting participant. The render component 130 can render live meeting information from the incoming data stream and captured meeting information from the buffer 110 seamlessly. The render component 130 may also render multiple streams at the same time, allowing the meeting participant to view live and captured meeting information simultaneously. For example, a meeting participant may keep the live meeting in a background window while displaying previous meeting data in a foreground window. The render component 130 also provides capabilities for playing back captured meeting information at a rate different than it was originally presented. For example, a latecomer to a meeting may playback the first few minutes of the meeting at twice the normal speed to catch up. The render component 130 may also apply pitch correction to meeting information played back at a different rate so that participants voices have their recognizable normal pitch.

The seek component 140 receives information about previous meeting data that the meeting participant wants to view and transitions between the recorded and live versions of a meeting. The seek component 140 may present a timeline or other controls for recording.

The user interface component 150 interacts with the user to direct the other components of the system and provide information to the user. For example, the render component 130 displays meeting information using the user interface component 150 and the seek component 140 receives information about what meeting data the user currently wants to view using the user interface component 150. The user interface component also displays to the user status information provided by the status component 170 and notifications provided by the notification component 160.

The notification component 160 receives notifications from other meeting participants or server, based on the meeting data that may be of interest to a meeting participant viewing previous meeting data. For example, if a user is reviewing meeting events from 5 minutes ago, and a meeting presenter wants to hold a vote in the live meeting, the meeting presenter or server may send a notification to the meeting participants to return to the live meeting. A meeting participant may indicate to the asynchronous meeting system certain events that are relevant to the participant and the system will notify the participant if one of the events occurs. For example, the participant may indicate that when a particular other participant speaks the participant would like to receive a notification. As another example, the participant may indicate that when a particular topic is being discussed the participant wants to be notified. The system can determine topics being discussed by reading meeting tags assigned by a meeting moderator or by using speech recognition to listen for keywords.

The status component 170 maintains the status of each meeting participant, including whether each participant is viewing live or recorded meeting information. The status component 170 distributes status information between participants of the meeting so that participants are informed of each others' status. This can allow a meeting participant to take action to get another participant's attention, such as if the other participant is not viewing live meeting data. For example, the meeting participant could send a notification to the other meeting participant using the notification component 160.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

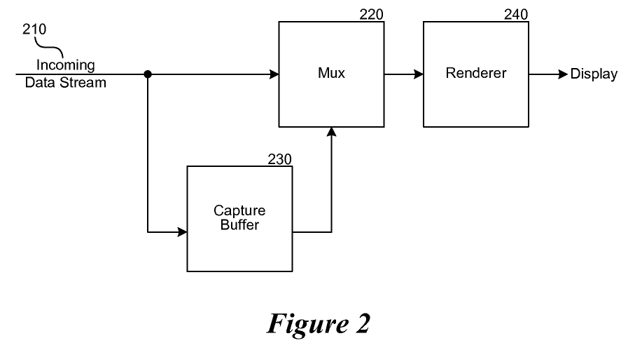

FIG. 2 is a block diagram that illustrates the flow of meeting data in the asynchronous meeting system, in one embodiment. The incoming data stream 210 is directed both through a multiplexer 220 to the renderer 240 and to the capture buffer 230 at the same time. In addition, the capture buffer 230 data is also directed through the multiplexer 220 to the renderer 240. Previous live meeting systems do not have a meeting buffer, and previous recorded meeting systems direct all data through the capture buffer before reaching the renderer 240. By feeding data to the renderer 240 from both the incoming data stream 210 and the capture buffer 230 at the same time, the asynchronous data system allows the multiplexer 220 to select which stream to display to a meeting participant at any given time. The capture buffer 230 records all data and events, and can render this data upon request to the client. In some embodiments, the asynchronous meeting system uses the capture buffer 230 for asynchronous mode and a copy of the incoming data stream 210 for synchronous mode. The capture buffer 230 can be temporary disk storage that is cleared at the end of the meeting session or another suitable storage medium. The asynchronous meeting system allows the capture buffer 230 to be saved off at any time before it is flushed to enable saving the meeting, even as an afterthought.

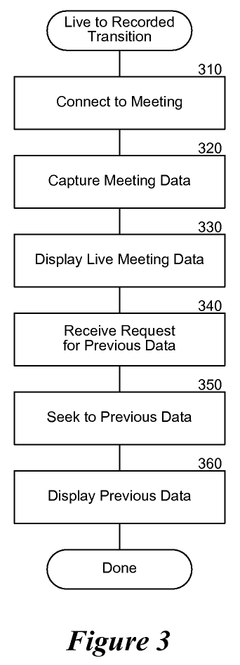

FIG. 3 is a flow diagram that illustrates processing of the seek component to seamlessly transition from live to previously recorded meeting data, in one embodiment. In block 310, the component connects to a meeting. For example, a user may receive an email invitation with a link to connect to an Internet-based meeting. The user activates the link, and a client meeting console (e.g., Microsoft Live Meeting) launches on the users client. In block 320, the component begins capture meeting data. For example, the component may store information received over the network in a capture buffer. Alternatively or additionally, the component may request additional information, such as source documents for documents presented at the meeting. The server may also store a buffer of the meeting data, so that a client that joins the meeting late can request previous meeting data from the server. In block 330, the component begins displaying live meeting data received from the server or another meeting participant (e.g., in a peer-to-peer meeting system). For example, the component may send data directly from the input data stream to a renderer.

In block 340, the component receives a request to view previous data from the meeting. For example, the user may seek to a different time in the meeting using a slider bar control representing a timeline of the meeting, or the user may open a document being presented at the meeting and navigate away from the page currently being presented. Each of these actions singles the asynchronous meeting system to switch from displaying the live meeting data to displaying buffered, previous meeting data. In block 350, the component locates and seeks to the previous meeting data requested by the user. For example, the component may switch the renderer from live incoming data to the buffer and locate the position within the buffer where the information is stored that the user wants to view. In block 360, the component displays the previous meeting data requested by the user. The component may display the previous meeting data in a separate window to communicate to the user that the data is not from the live meeting. The component may also allow the user to see both the live and previous meeting data simultaneously, such as in separate windows, so that the user can review earlier proceedings of the meeting while staying aware of actions going on in the live meeting. After block 360, these steps conclude.

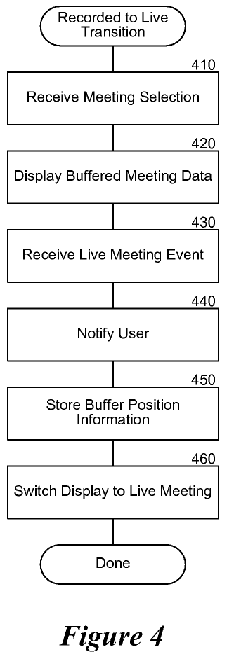

FIG. 4 is a flow diagram that illustrates processing of the seek component to seamlessly transition from previously recorded meeting data to live meeting data, in one embodiment. In block 410, the component receives a selection of a meeting if the user is not already in a meeting. For example, the user may accept an email invitation to a web-based meeting as described above. Alternatively, the user may already be in a meeting and viewing previous meeting data as described in FIG. 3. In block 420, the component displays previous meeting data, such as from a capture buffer. For example, previous meeting data may include video, audio, documents, or shared application data presented during the meeting. In block 430, the component receives notification of an event that occurred in the live meeting. For example, a meeting presenter may notify meeting participants to return to the live meeting or a the user may have requested that the system notify him/her when particular meeting content was discussed (e.g., a document page being presented or a keyword being spoken).

In block 440, the component notifies the user of the event. For example, the component may display a dialog box or display an alert message in one corner of the window the user is viewing. The component may allow the user to dismiss the notification or click a button to return to the live meeting from the notification window. In block 450, the component may optionally store information about the position in the stored meeting data that the user was previously viewing before transitioning to the live meeting data. This allows the user to later return to the data the user was viewing. In block 460, the component switches from rendering the buffered data to rendering the live meeting data. The component may also perform the switch by seeking to the most recently buffered data, although this can add latency that the user may perceive. After block 460, these steps conclude. The system may also support partial switching (e.g., where only the audio or video is switched) using the steps described.

In some embodiments, the asynchronous meeting system allows audio from the synchronous mode to be muted or redirected to another output device (e.g., live meeting audio to speakers and recorded meeting to a headset) while a participant is in asynchronous mode. For example, the participant may want to listen to something another participant said at the beginning of the meeting and not have the current meeting audio playing over it. Alternatively, the participant may want the current meeting audio to play quietly in the background so that the participant can follow it peripherally. This can help the participant keep track of the background conversation for quick participation as needed. The system allows the user to specify how the system handles meeting audio in each mode.

In some embodiments, the asynchronous meeting system switches to recorded meeting data when the user selects a pause button. For example, when the user presses the pause button, the system may stop rendering meeting data to the users computer system and prompt the user with a choice to either resume rendering the meeting data or skip elsewhere in the meeting timeline. The system may also allow the user to take a different action with respect to various parts of the meeting. For example, the user could resume the display of current video meeting data but request the playback of audio meeting data from earlier in the meeting.

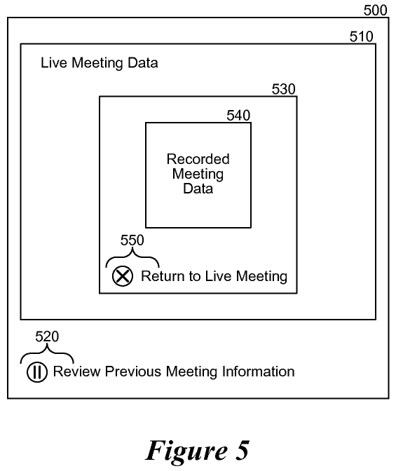

FIG. 5 is a display diagram that illustrates a user interface of the asynchronous meeting system for displaying live and recorded meeting information at the same time, in one embodiment. The user interface 500 contains a live meeting window 510, live meeting controls 520, and a recorded meeting window 530. The live meeting window 510 displays the live meeting with the current meeting data. For example, the live meeting window 510 may display a page of a document that a presenter is currently discussing. The live meeting controls 520 include controls for controlling the system, such as pause button for stopping the live meeting and viewing recorded meeting data. Alternatively, the system may display a review button that does not stop the live meeting but displays the recorded meeting data in a separate recorded meeting window 530 while the live meeting still plays in the live meeting window 510. The recorded meeting window 530 contains a recorded meeting data display area 540 and one or more recorded meeting controls 550 for modifying the recorded meeting behavior. The recorded meeting controls 550 may include controls for skipping forward or backward within the recorded meeting data, accelerating the playback rate of the recorded meeting data, and closing the recorded meeting window 530 to return to the live meeting.

In some embodiments, the asynchronous meeting system provides a notification to a meeting participant that is viewing previous meeting data that an event has occurred in the live meeting. For example, the system may inform the meeting participant when a particular keyword is detected in the audio of the meeting, such as the meeting participant's name or a topic of interest to the meeting participant. As another example, the meeting participant may request notification when a particular page of a document presented at the meeting is being discussed or when a particular other participant speaks. Upon receiving the notification, the meeting participant can return to the live meeting.

In some embodiments, the asynchronous meeting system allows other meeting participants to notify a meeting participant that is viewing previous meeting data to return to the live meeting. For example, if the meeting organizer wants to conduct a vote, the meeting organizer might request that all participants return to the live meeting to cast their vote. The system may notify a participant by displaying a message or shaking the user interface (similar to an instant messaging wink or nudge) to get the participant's attention. The participant can return to the live meeting and later return to the previous meeting data that the participant was reviewing.

In some embodiments, the asynchronous meeting system displays the status of each meeting participant, including whether participants are currently viewing the live meeting or previous meeting data. The system may maintain and distribute presence information for each participant to other participants. When a participant enters asynchronous mode, such as by selecting the pause button, the system updates the participant's status to reflect that the participant is no longer viewing the live meeting. The participant's status is distributed to other participants through the participant's presence information. The presence information may be conveyed via a text status message or by changing an icon to reflect the participant's current status.

In some embodiments, the asynchronous meeting system allows participants to tag various parts of a meeting with user-defined tags. The tags may describe an event that occurred or a transition from one topic to the next. Meeting participants can use the tags to later return to a part of the meeting of particular interest. A participant that joins the meeting late or viewing the meeting after the meeting has concluded can use the tags to skip around within the meeting to find content of interest to the participant.

In some embodiments, meeting participants that physically attend the meeting can use the features of the asynchronous meeting system described herein. For example, participants that are physically present may bring a laptop to the meeting and may use the asynchronous meeting system to skip around within documents presented at the meeting. If the participant has headphones or a Bluetooth headset, the participant may be able to review earlier audio of the meeting without disturbing others present at the meeting.

In some embodiments, the asynchronous meeting system provides visual cues to indicate the activity of the live meeting to an asynchronous meeting participant. For example, if a presenter is displaying page 5 of a document and the asynchronous participant is viewing page 3 of the document, then the system may overlay an arrow on the document pointing towards page 5 (e.g., the bottom of the screen) to indicate to the asynchronous participant where the presenter is currently presenting. The system may allow the participant to select the visual cue to catch up. For example, if the participant clicks the arrow, the system may navigate the document to the page the presenter is currently presenting.

From the foregoing, it will be appreciated that specific embodiments of the asynchronous meeting system have been described herein for purposes of illustration, but that various modifications may be made without deviating from the spirit and scope of the invention. Accordingly, the invention is not limited except as by the appended claims.

I/We claim:

1. A method of switching between live and recorded versions of a web-based meeting, the method comprising:
connecting to a web-based meeting, wherein the meeting comprises two or more meeting participants;
capturing meeting data to a buffer;
displaying live meeting data of the web-based meeting;
receiving a request to view previous data of the meeting; and
seeking within the captured meeting data to the requested previous meeting data;
displaying the previous meeting data.

2. The method of claim 1 wherein the request to view previous meeting data specifies previous visual meeting data so that while displaying the previous visual meeting data, audio of the live meeting plays in the background.

3. The method of claim 1 wherein capturing the meeting data comprises capturing documents presented at the meeting in the original document format.

4. The method of claim 1 wherein receiving a request to view previous meeting data comprises receiving an indication that a user has selected a pause button.

5. The method of claim 1 wherein receiving a request to view previous meeting data comprises a user navigating a document to a page other than the page a meeting presenter is navigated to.

6. The method of claim 1 further comprising, after receiving the request, updating a first meeting participant status to indicate to other meeting participants that the first meeting participant is viewing previous meeting data.

7. The method of claim 1 further comprising, while displaying previous meeting data, receiving a notification that an event has occurred in the live version of the web-based meeting.

8. The method of claim 1 further comprising, while displaying previous meeting data, receiving a notification that a meeting presenter wants other participants to display the live version of the meeting.

9. The method of claim 1 wherein displaying previous meeting data comprises displaying the previous meeting data at a rate faster than the previous meeting data was displayed live.

10. The method of claim 1 wherein the live and previous meeting data are displayed simultaneously in separate windows.

11. A computer system for providing asynchronous meeting experiences to a meeting participant, the system comprising:
a capture component configured to store meeting information to a buffer, wherein the meeting information includes documents presented during the meeting;
a render component configured to render live meeting information received over a network and stored meeting information from the buffer; and
a seek component configured to provide seamless switching between the live meeting information and the stored meeting information.

12. The system of claim 11 further comprising a notification component configured to notify the computer system when an event occurs during the live meeting.

13. The system of claim 11 further comprising a status component configured to communicate the status of the computer system to other computer systems associated with the meeting.

14. The system of claim 11 further comprising a user interface component configured to interact with a meeting participant to determine which meeting data to display at a given time.

15. A computer-readable medium containing instructions for controlling a computer system to switch between a recorded and live version of an online meeting, by a method comprising:
receiving a selection of a live online meeting, wherein the live online meeting has data that is being recorded to a buffer;
displaying to a user the recorded meeting data starting at the beginning of the buffer;
receiving an indication that an event has occurred in the live online meeting;
notifying the user that the event occurred;
switching from displaying the recorded meeting data to displaying the live online meeting.

16. The computer-readable medium of claim 15 wherein the event is the speaking of a keyword by a meeting participant.

17. The computer-readable medium of claim 15 wherein the event is a request by a meeting presenter to have all participants return to the live meeting.

18. The computer-readable medium of claim 15 wherein displaying the recorded meeting data comprises displaying the buffered data at a rate faster than an original rate at which the data was presented, and, when the computer system catches up to the live meeting, displaying live meting data.

19. The computer-readable medium of claim 15 wherein displaying to a user the recorded meeting data comprises displaying a visual cue that indicates the direction in the meeting data that a meeting presenter is currently viewing.

20. The computer-readable medium of claim 15 further comprising, before switching to the live online meeting, storing position information indicating a location in the buffer that the user was viewing so that the user can return to the same location later.
